(19) United States
(12) Patent Application Publication
(10) Pub. No.: US 2026/0080225 A1
(43) Pub. Date: Mar. 19, 2026

(54) SUBMITTER SPECIFIC GENERATIVE MODEL ROUTING

(71) Applicant: GOOGLE LLC, Mountain View, CA (US)

(72) Inventors: Parashar Shah, Newcastle, WA (US); Aditya Krishna Menon, New York, NY (US); Anqi Mao, Jersey City, NJ (US); Dmitry Storcheus, New York, NY (US); Harikrishna Narasimhan, Sunnyvale, CA (US); Javier Gonzalvo, New York, NY (US); Mehryar Mohri, New York, NY (US); Seungyeon Kim, New York, NY (US); Wittawat Jitkrittum, Jersey City, NJ (US); Yutao Zhong, Jersey City, NJ (US); Chen-Yu Lee, Cupertino, CA (US); Zifeng Wang, Los Angeles, CA (US); Fanglin Lu, Palo Alto, CA (US); Paramjit Singh Sandhu, Sunnyvale, CA (US); Wenjie Yuan, Cupertino, CA (US); Anand R. Iyer, Sunnyvale, CA (US); Apurv Suman, New York, NY (US); Venkatraman Subramanian, Bangalore (IN); Salem Elie Haykal, Seattle, WA (US)

(21) Appl. No.: 19/327,517

(22) Filed: Sep. 12, 2025

(30) Foreign Application Priority Data
Sep. 18, 2024 (IN) IN202411070591

(51) Int. Cl. G06N 3/0475; G06N 3/045; G06N 3/08

(52) U.S. Cl. CPC G06N 3/0475; G06N 3/045; G06N 3/08

(57) ABSTRACT

Implementations disclose selecting, in response to receiving a generative model request and from among multiple candidate generative models, a particular generative model to utilize in generating a response to the generative model request. Various implementations identify an indication of a submitting entity of the generative model request. The particular generative model can be selected based on processing the generative model request and custom selection feature(s) provided by the submitting entity (e.g., provided well in advance of the generative model request). Different submitting entities (e.g., a first and second entities) can have different custom selection features. Accordingly, even if the first and second submitting entities submit the same generative model request, different generative models are selected to process the generative model request, resulting in two different responses, one responsive to the first entity and the other responsive to the second entity.

### BACKGROUND

Various generative models have been proposed that can be used to process natural language (NL) content, image content, audio content, and/or other input(s), to generate output that reflects generative content that is responsive to the input(s). For example, large language models (LLM(s)) have been developed that can be used to process NL content and/or other input(s), to generate LLM output that reflects generative NL content and/or other generative content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”. However, current utilization of generative models suffers from one or more drawbacks.

As one example, many generative models can be of a very large size, often including billions of parameters (e.g., over 100 billion parameters, over 250 billion parameters, or over 500 billion parameters). Due to the large size of such a generative model, significant memory, processor, power, and/or other computational resource(s) can be required to process an input, using the generative model, to generate a corresponding generative output. This resource utilization can be significant on a per input basis, and be very significant when hundreds or thousands of inputs are being processed per minute, per second, or other interval. Also, due to the large size of such a generative model, there can be significant latency in generating a corresponding generative output and, as a result, in rendering corresponding generative content. Such latency can lead to prolonging of a user-to-computer interaction.

Smaller size counterparts to such generative models do exist, such as a separately trained counterpart with fewer parameters or a pruned and/or quantized counterpart generated from applying one or more pruning techniques and/or one or more quantization techniques to the larger counterpart. For example, a smaller counterpart to a larger model can include 25%, 33%, 50%, 66% or other percentage less parameters than the larger model. However, such smaller size counterparts can be less robust and/or less accurate than their larger size counterparts. Accordingly, while utilizing such a smaller size counterpart to process an input can be more computationally efficient and/or can be performed with less latency, there is a greater risk that corresponding generative output, generated by processing the input, can be inaccurate and/or under-specified.

### SUMMARY

Implementations disclosed herein relate to methods and systems for leveraging one or more routing models in dynamically selecting a generative model, from a set of generative models, to utilize in generating a response to a generative model request. For example, implementations relate to selecting only a single generative model to utilize in generating the response and without utilizing any other of the generative model(s) of the set in generating the response. The set of generative models can include a total quantity (K) generative models, where each of the K generative models differs from all other of the K generative models. For example, a given generative model can differ from all others by being of a different size (e.g., different quantity of parameters), by having a different maximum context window, by having different input modalities and/or output modalities, by having different trained weight(s), and/or by having other differing feature(s).

As described herein, in dynamically selecting a generative model for a generative model request, various implementations select the generative model based on one or more custom selection features that are specific to a submitting entity that submitted the generative model request. For example, various implementations, in selecting a generative model for a generative model request, identify (e.g., based on metadata of the generative model request) a submitting entity for the generative model request, identify selection features that are specific to the submitting entity, and utilize those identified selection features in selecting the generative model.

Many of those various implementations, in dynamically selecting a generative model for a generative model request, further utilize content of the generative model request itself, along with also utilizing the custom selection features that are specific to the submitting entity. For example, content of the generative model request can be processed using a first routing model to generate corresponding content-based scores for each of the generative models of the set, then the content-based scores can be utilized, along with custom selection features, in selecting one of the generative models of the set. For instance, the content-based scores can be processed using a second routing model, that is fine-tuned (e.g., via a low-rank adaptation (LoRA) adapter) based on the custom selection features (e.g., based on training instances that reflect the custom selection features), to generate corresponding custom-selection scores for the each of the generative models of the set, and those custom-selection scores are utilized in selecting one of the generative models of the set. Also, for instance, the content-based scores and a description of the custom selection features can be processed using a second routing model, to generate corresponding custom-selection scores (customized through processing of the description of the custom selection features) for the each of the generative models of the set, and those custom-selection scores are utilized in selecting one of the generative models of the set. Considering both content of the generative model request and custom selection features can enable more computationally efficient and/or lower latency generative models to be utilized when appropriate, while mitigating occurrences of incorrect or underspecified generative responses being provided responsive to generative model requests.

More generally, implementations disclosed herein seek to mitigate various drawbacks of dynamically routing different generative model requests to different generative models based on (i) considering content of the generative model request without also considering custom selection feature(s) of a submitting entity that submitted the generative model request or based instead on (ii) considering custom selection feature(s) of a submitting entity that submitted the generative model request without consideration of the content of the generative model request. For example, routing generative model requests based on (i) or based on (ii) can result in occurrences of utilizations of generative models that are less computationally efficient and/or higher latency than needed, which results in undue utilization of computational resources. Also, for example, routing generative model requests based on (i) or based on (ii) can result in occurrences of utilization of generative models that are more computationally efficient than needed and/or lower latency than needed, which can result in incorrect generative responses, which can cause safety issues or other erroneous conditions and/or which can cause additional request(s) to be submitted (in an attempt to obtain a correct generative response).

As a non-limiting example, assume a first submitting entity is an electrician or electrical company that submits on the job generative model requests and that the first submitting entity has previously defined custom selection feature(s) of a quality feature of “99 of 100” (where 100 is most indicative of quality and 1 is least indicative) and a latency feature of “25 of 100” (where 100 is indicative of least latency and 1 is indicative of most latency). The 99 of 100 quality feature can reflect that the first submitting entity wants to ensure accuracy of generative model responses to mitigate unsafe conditions and the 25 of 100 latency feature can reflect that the first submitting entity can accommodate a reasonable latency in receiving a generative model response. Further assume a second submitting entity is an electrical salesperson or electrical store that submits generative model requests to assist with general customer questions and that the second submitting entity has previously defined custom selection feature(s) of a quality feature of “70 of 100” and a latency feature of “90 of 100”. The 70 of 100 quality feature can reflect that the first submitting entity wants to ensure relatively accurate generative model responses but can handle non-fully accurate responses as no immediate installation actions will take place based on the responses and the 90 of 100 latency feature can reflect that the second submitting entity wants low-latency responses to minimize customers' waiting duration.

Continuing with the example, assume a multimodal generative model request is received that includes an image of a thermostat and natural language text of “can I hook up a heat pump wire to this”. Submission of the generative model request from the first entity can result in a first generative model (e.g., a first VLM) being selected and used to generate a first generative model response, whereas submission of the same generative model request from the second entity can result in a distinct second generative model (e.g., a second VLM) being selected and used to generate a second generative model response. This differing selection results from considering the differing custom selection features of the first and second entities. However, assume an alternative generative model request is received that is “what is the most common color for a ground wire in the US”. Submission of the alternative generative model request from the first entity can result in a third generative model (e.g., an efficient LLM) being selected and used to generate a third generative model response, and submission of the same alternative generative model request from the second entity can likewise result in the third generative model being used to generate the third generative model response. Using the same third generative model, for the alternative generative model request, results from considering the content of the alternative generative model request. For example, a first routing model can be used to indicate that a computationally efficient model is highly capable of generating an accurate response to this relatively simple generative model request, and processing by second routing model(s) will not override the indication from the firs routing model.

As referenced above, in some implementations content of the generative model request can be processed using a first routing model to generate corresponding content-based scores for each of multiple generative models of a set, then the content-based scores can be utilized, along with custom selection features, in selecting one of the generative models of the set. In some of those implementations, the content-based scores can be processed using a second routing model, that is fine-tuned (e.g., via utilization of a fine-tuned LoRA adapter) based on custom selection features for a submitting entity that submitted the generative model request. For example, the submitting entity can provide positive and/or negative training instances and those training instances utilized to fine-tune the second routing model (e.g., via training of a corresponding LoRA adapter). Each of the training instances can include training instance input that reflects a corresponding generative model request and can include training instance output that reflects which or multiple generative models should be selected. In some additional or alternative of those versions, the content-based scores and a description of the custom selection features (e.g., a corresponding submitting entity defined magnitude for each of the custom selection features) can be processed using a second routing model, to generate corresponding custom-selection scores for the each of the generative models of the set, and those custom-selection scores are utilized in selecting one of the generative models of the set.

The one or more routing models, utilized in dynamically selecting a generative model from the set of generative models, can include a machine learning (ML) model, such as a neural network model. In some implementations, the ML model can be trained using different loss functions to perform model selection, where the loss function can be based on learning to defer to an expert model and/or post-hoc routing. In various implementations, optionally, a system can include one or more cloud storage systems that store or host the set of generative models (or a portion thereof), or can include an application programming interface (API) of a routing application that accesses the set of generative models (e.g., via the one or more cloud storage systems). The system can further include, or access, the one or more routing models for selecting one of the set of generative models in generating a response for a generative model request (may also referred to as “system request”, etc.) submitted by a submitting entity (e.g., a query-submitting entity or a request-submitting entity). The cloud storage system or the routing application can be referred to as a first-party application that stores or accesses the set of generative models. The submitting entity, for instance, can be a third-party application that is different (and separate) from the first-party application (e.g., the cloud storage system, or the routing application).

In various implementations, the generative model request is to be processed using a generative model. In some of the various implementations, the generative model request can be derived from a user query received via a user interface (e.g., audible, or graphical) of the third-party application. For example, given a user query (“what dress would you recommend for a black tie event”) received via a third-party application of a submitting entity which is a clothing merchant, the generative model request can include the user query and/or include additional information provided by the submitting entity in association with the user query (or a user of the user query). The additional information can include, for instance, an inventory of products (e.g., clothes) available to purchase from the clothing merchant and description data describing each available piece (e.g., dress, top, bottom, accessories, etc.) of the products (e.g., clothes) available. The additional information can additionally or alternatively include, for instance, an identification (e.g., gold or silver membership) of a user of the user query (“what dress would you recommend for a black tie event”). Descriptions of the additional information are not intended to be limiting.

In some of the various implementations, the generative model request can be derived from a system query submitted by the third-party application, and not derived from a user query submitted by a user (e.g., human user) of the third-party application. For example, the third-party application can generate a generative model request based on a system query (e.g., “provide a summary of sales for the day and any insights”) submitted by developer(s) of the third-party application. In this example, the generative model request can be, for instance, “provide a summary of sales for the day and any insights based on the following data: [electronic sales data for the day]”. The generative model request can be transmitted to the first-party application (e.g., the routing application), for the routing application to select a generative model to process the generative model request.

In various implementations, developer(s) of the third-party application can provide one or more model selection constraints to the system prior to (or in response to) receiving the generative model request. The system (e.g., the routing application) can select the generative model for processing the generative model request based on the one or more model selection constraints that are defined by the developer(s) of the third-party application and/or based on the generative model request. Different third-party applications can provide different sets of selection constraints to the routing application/system. For example, developers of a first third-party application (e.g., a bitcoin transaction application) may provide a safety constraint indicating a high degree of safety and a quality constraint indicating a high degree of quality. In contrast, developers of a second third-party application (e.g., a toy company application) may provide a safety constraint also indicating the high degree of safety, but a quality constraint indicating a medium degree of quality. In this case, the same query received from the first and second third-party applications can be processed using different generative models (e.g., a first generative model vs. a second generative model) selected using the routing application.

In various implementations, the one or more routing models can include a first routing model (sometimes referred to as a “static model router”) and/or a second routing model (e.g., sometimes referred to as a “dynamic selector model”). The static model router can be, or can include, a neural network trained or fine-tuned to process a first generative model request (e.g., received from the first third-party application) as input, to generate a first routing model output indicating a set of selection scores (selection score_1, selection score_2, . . . , selection score_K). Each selection score (e.g., selection score_i), from the set of selection scores, corresponds to a respective generative model (e.g., generative model_i) from the set of generative models (e.g., generative model_1, generative model_2, . . . , generative model_K) that are accessible via (e.g., hosted at) the cloud storage system(s).

In various implementations, the static model router can be acquired based on training or fine-tuning a first neural network using a first set of training instances. For instance, the first set of training instances can include a first training instance input and a first ground truth output. The first training instance input can include a first training request, where the first training request can be processed using the static model router to generate a first training instance output. The first training instance output can be compared with the first ground truth output, to determine a difference. Based on the difference, one or more parameters of the first neural network can be modified. In some implementations, during inference (e.g., selecting a particular generative model to process the first generative model request), parameters of the first neural network can be frozen (e.g., remain unchanged).

In various implementations, the dynamic selector model can be configured to process as input, the set of selection scores and one or more constraints specific to the first third-party application, to generate a model output indicating a selection of a particular generative model from the set of generative models. The selected particular generative model can be used to process the first generative model request (e.g., received from the first third-party application), to generate a generative model output reflecting a response responsive to the first generative model request. The response can be rendered, e.g., via the first third-party application, in response to the user query. For example, the first third-party application can receive the response, and cause the response to be rendered visually (and/or audibly), via a graphical user interface (and/or an audible user interface) of the first third-party application.

In various implementations, the dynamic selector model can be customized or updated based on one or more examples provided by the first third-party application.

By implementing one or more aspects of the various implementations described above and elsewhere in this disclosure, a generative model can be dynamically selected from a plurality of generative models for processing a generative model request submitted by a submitting entity (e.g., a third-party application), based on the generative model request and based on one or more constraints specific to the third-party application. By specifying the one or more constraints, e.g., via sliders presented via a user interface of a display, the routing system can tailor the selection of the generative model in processing a system request from a third-party application, to cope with specific requirements (e.g., in safety level, maximum cost limit, maximum latency levels or a minimum throughput, a quality level or score) of the third-party application.

While the one or more routing models are described in some examples above as including two separate models (e.g., the static model router and the dynamic selector model), the one or more routing models can include a single model to select a model from the set of generative models in order to process the generative model request. For example, in various implementations, a method implemented using one or more processors is provided. The method can include: receiving a generative model request, where the generative model request is received from a submitting entity. In response to receiving the generative model request, the method can further include: identifying one or more custom selection features that are customized by the submitting entity; selecting, based on processing the generative model request and the identified one or more custom selection features, a particular generative model from a set of generative models; and causing the generative model request to be processed using the selected particular generative model.

In some of the various implementations, a system via which the method is performed can select the particular generative model from the set of generative models by: processing the generative model request and the identified one or more custom selection features, using one or more routing models, to generate a model selection indication that indicates the particular generative model being selected; and selecting the particular generative model based on the model selection indication that indicates the particular generative model being selected.

The preceding is presented as an overview of only some implementations disclosed herein. There can be various other implementations. For example, while the descriptions above relate to selecting a generative model from a set of generative models, techniques described herein may enable selection of a machine learning model, from a plurality of machine learning models, e.g., based at least on custom selection features customized by the submitting entity that submits a request for processing using one of the plurality of machine learning models.

These and other implementations are disclosed in additional detail later in this disclosure. For example, various implementations can include one or more transitory and/or non-transitory computer readable storage medium storing instructions executable by one or more hardware processors (e.g., central processing unit(s), graphics processing unit(s), tensor processing unit(s), and/or other processor(s)) to perform a method such as one or more of the methods described herein. Other implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B depicts a block diagram of another example environment that demonstrates various aspects of the present disclosure, and in which some implementations disclosed herein can be implemented.

FIG. 2A illustrates an example of interactions, between components of FIG. 1A, that can occur in selecting, in response to receiving a request and from among multiple candidate generative models with differing computational efficiencies, a particular generative model to utilize in generating a response to the request.

FIG. 2B illustrates an example of interactions between components of FIG. 1A, that can occur in selecting, in response to receiving a different request and from among multiple candidate generative models with differing computational efficiencies, a different particular generative model to utilize in generating a different response to the different request.

FIG. 3A illustrates an example routing system that demonstrates various aspects of the present disclosure, and in which some implementations disclosed herein can be implemented.

FIG. 3B illustrates another example routing system that demonstrates various aspects of the present disclosure, and in which some implementations disclosed herein can be implemented.

FIG. 4A depicts a flowchart illustrating an example method of selecting, in response to receiving a request and from among multiple candidate generative models with differing computational efficiencies, a particular generative model to utilize in generating a response to the request.

FIG. 4B depicts a flowchart illustrating an example method of selecting, in response to receiving a request and from among multiple candidate generative models with differing computational efficiencies, a particular generative model to utilize in generating a response to the request.

FIG. 5 depicts an example architecture of a computing device, in accordance with various implementations.

FIG. 6 depicts an example flowchart illustrating training or fine-tuning of a routing model (e.g., 121C in FIG. 3B) that demonstrates various aspects of the present disclosure, and in which some implementations disclosed herein can be implemented.

### DETAILED DESCRIPTION

As described previously, given a generative model request derived from a query submitted by a submitting entity (e.g., a user of a client device, a developer of a third-party application, etc.), there can be many generative models available to process the generative model request, so as to generate a response that is responsive to the generative model request. It is not always the case that the generative model with the highest amount of parameters provides the most desired response for the generative model request submitted by the submitting entity. For example, while the generative model with the highest amount of parameters may provide a most accurate response for a given generative model request, the submitting entity of the query may look for a response generated with reduced latency and having a medium level of quality/accuracy (instead of a response generated with a highest level of quality/accuracy). As a result, for the generative model request submitted by the submitting entity, there is a need to select a generative model that balances one or more factors/constraints (e.g., cost, quality, latency, throughput, safety, etc.) provided (e.g., customized) by the query-submitting entity. This way, different submitting entities (e.g., a first application vs. a second application) can provide different factors or constraints for model selection.

Various implementations provide machine learning frameworks that enable model selection based on submitter-specific selection features/constraints, such as a submitter defined safety score or safety level, or a submitter selected safety score (or safety level) selected from a plurality of predefined safety scores (or a plurality of predefined safety levels). However, this is not meant to be limiting. Various implementations also enable model selection based on other submitter-specific selection features/constraints, such as a quality score (or a quality level), a cost limit, a latency limit (or a throughput requirement), a resilience score, etc. Using one or more machine learning (ML) models for selection of a generative model from a set of generative models in processing a generative model request reduces or eliminates the need to actually perform an inference stage using each generative model from the set which consumes intensive computational resources and elongated time. Using one or more machine learning (ML) models for selection of a generative model further enables submitter-specific generative model routing, where given the same generative model request but different submitter-specified selection features/constraints, different generative models can be selected for different submitters of the generative model request in generating correspondingly desired responses (e.g., a first response generated satisfying a higher quality requirement for a first submitter of the generative model request vs. a second response generated in align with a higher safety requirement for a second submitter of the generative model request).

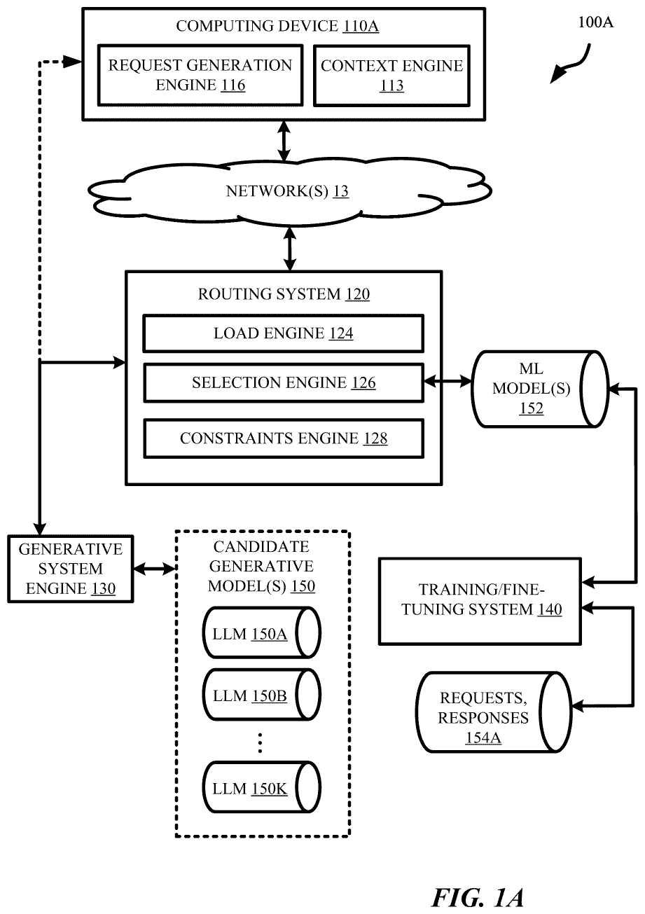

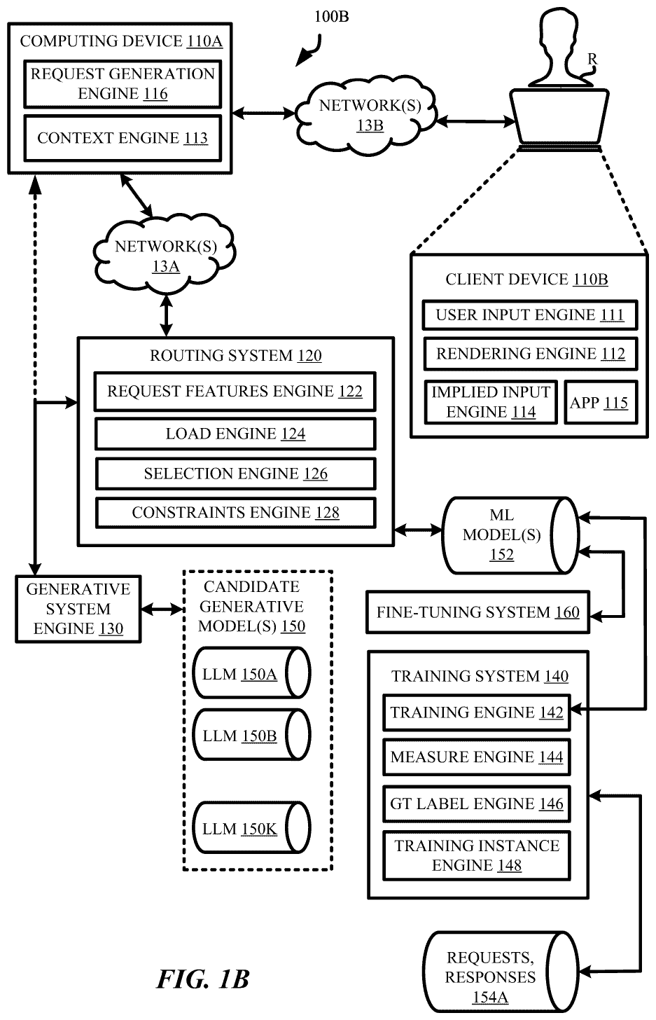

FIG. 1A depicts a block diagram of an example environment that demonstrates various aspects of the present disclosure, and in which some implementations disclosed herein can be implemented. FIG. 1B depicts a block diagram of another example environment that demonstrates various aspects of the present disclosure, and in which some implementations disclosed herein can be implemented. Turning now to FIG. 1A, a block diagram of an example environment 100A that demonstrates various aspects of the present disclosure, and in which implementations disclosed herein can be implemented is depicted.

The example environment 100A includes a computing device 110A, a routing system 120, a generative system 130, and a training/fine-tuning system 140. The computing device 110A can include, for instance, a request generation engine 116 and/or a context engine 113. In some implementations, the example environment 100A further includes ML model(s) 152 that can optionally be used by the routing system 120 as routing model(s), candidate generative models 150 that are utilized/accessed by the generative system 130, and a database 154 that can optionally be used by the training/fine-tuning system 140 in training or fine-tuning the ML model(s) 152. The request generation engine 116 can generate a request (e.g., a generative model request) to be routed by the routing system 120 for processing using a generative model selected from the candidate generative models 150.

The context engine 113 can be configured to determine a context associated with the request (e.g., the generative model request generated by the request generation engine 116) and/or a context associated with the computing device 110A (and/or 110B in FIG. 1B). In some of those implementations, the context engine 113 can determine a location of the computing device 110A, profile data of a profile of a user of the computing device 110A, and/or metadata (e.g., sales data or other files) associated with the request (e.g., a generative model request to summarize weekly sales for a toy store). Descriptions of the context engine 113, however, are not limited herein. Optionally, the computing device 110A can include a user input engine 111. But this is not required. Descriptions of the user input engine 111 can be found later in this disclosure.

In some implementations, the training/fine-tuning system 140 can, for example, train or fine-tune one or more of the ML models 152 in selecting a candidate generative model from the candidate generative models 150. As a non-limiting example, the candidate generative models 150 of FIG. 1A can include LLM 150A, LLM 150B, . . . , and LLM 150K, where K is a positive integer greater than “1”. In some implementations, only two candidate generative models are included among the candidate generative models 150. In other implementations, three or more than three candidate generative models can be included among the candidate generative models 150 (e.g., 150A, 150B, . . . , 150K), as indicated by the vertical ellipsis in FIG. 1A. Each of the candidate generative models 150 can generate a response to the same request with differing latencies (or throughputs) or qualities, corresponding to differing hardware computational/serving costs, and is capable of safely handling different queries. As a non-limiting example, LLM 150A can have less than 100 billion parameters, LLM 150B can have between 100 billion and 250 billion parameters, and LLM 150K can have over 250 billion parameters. Although LLMs 150A, 150B, . . . , and 150K are illustrated as being included in the candidate generative models 150 in FIG. 1A (or FIG. 1B), additional or alternative generative models can be included such as text-to-image diffusion model(s).

In some implementations, LLMs 150A, 150B, . . . , and 150K can be accessed via a single source that provides (or hosts) generative models. For example, LLMs 150A, 150B, . . . , and 150K can be accessed via a single generative system (e.g., a single cloud storage platform) that hosts LLMs 150A, 150B, . . . , and 150K. In some implementations, LLMs 150A, 150B, . . . , and 150K can be accessed via different sources that each provide a distinct group of generative models. For example, LLM 150A can be accessed via a first generative system (e.g., a first cloud storage platform) that hosts or access LLM 150A, LLM 150B can be accessed via a second generative system (e.g., a second cloud storage platform different from the first platform) that hosts or accesses LLM 150B, and the rest LLM(s) can be accessed via a third generative system (e.g., a third cloud storage platform) that is different from the first and second generative systems.

While the candidate generative models 150 are illustrated in FIG. 1A as including LLM 150A, LLM 150B, . . . , and LLM 150K, the total number, type(s), and/or configurations of the candidate generative models 150 are not limited thereto. For instance, the candidate generative models 150 can include one or more generative models other than LLM(s). Additionally, while the present disclosure describes selecting a generative model from the candidate generative models 150, this is not intended to be limiting. For example, the ML model(s) 152 may be trained or fine-tuned to select a ML model (which may be, but does not need to be, a generative model), from a plurality of candidate ML models in processing one or more requests (e.g., generated by the request generation engine 116).

In some implementations, as illustrated in FIG. 1A or FIG. 1B, the routing system 120 can be separate from the generative system 130. For example, the routing system 120 and the generative system 130 can be controlled by separate entities/parties. In some implementations, all or some aspects of the routing system 120 and generative system 130 can be implemented as part of a cohesive system. For example, the same entity/party can be in control of both the routing system 120 and the generative system 130, and implement them cohesively.

In some implementations, the computing device 110A can interface with the routing system 120 utilizing, for example, an application programming interface (“API”) of the routing system 120. For example, the computing device 110A can transmit, using the API of the routing system 120, a request to be routed and processed using a generative model (e.g., LLM 150A, or a different LLM) selected from the candidate generative models 150. In some implementations, the routing system 120 can interface with the generative system 130 utilizing, for example, an API of the generative system 130. For example, the routing system 120 can transmit, using the API of the generative system 130, a generative model request and an indication of which generative model is to be selected/utilized in processing the generative model request. The indication can be generated, for instance, by the routing system 120 using one or more of the ML model(s) 152. The generative system 130 can be, for instance, a cloud storage system as described previously. Optionally, the example environment 100A can include more than one generative system. For example, the example environment 100A can include a first generative system that accesses a first group of generative models (e.g., LLM 150A), and a second generative system that accesses a second group of generative models different from the first group of generative models (e.g., LLM 150B˜150K). The present disclosure, however, is not intended to be limiting.

In some implementations, all or some aspects of the routing system 120 can be implemented locally at the computing device 110A. In additional or alternative implementations, all or some aspects of the routing system 120 can be implemented remotely at remote server(s) that are separate from the computing device 110A as depicted in FIG. 1A. In some implementations, the computing device 110A and the routing system 120 can be communicatively coupled with each other via one or more networks 13, such as one or more wired or wireless local area networks (“LANs,” including Wi-Fi LANs, mesh networks, Bluetooth, near-field communication, etc.) or wide area networks (“WANs”, including the Internet).

In some implementations, the computing device 110A can be a local server, or can be a client device, such as a desktop computer, a laptop computer, a tablet, a mobile phone, etc. In some implementations, referring to FIG. 1B, in an example environment 100B, the computing device 110A can be, for instance, a server device that includes, or that is communicatively coupled with the routing system 120 via one or more networks 13A. In this case, the server device 110A can be further communicatively coupled with a client device 110B via one or more additional networks 13B. The one or more networks 13A, and/or the one or more additional networks 13B can be, for instance, one or more wired or wireless LANs (including Wi-Fi LANs, mesh networks, Bluetooth, near-field communication, etc.) or WANs (including the Internet).

The client device 110B can be, for instance, a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

In some implementations, the client device 110B can execute one or more applications, such as an application (“App”, also referred to as “third-party application”) 115, via which a user query can be submitted, and/or via which a response generated using a generative model (e.g., which is selected from the candidate generative models 150) can be rendered (e.g., audibly and/or visually). The application 115 can be an application that is separate from an operating system of the client device 110B (e.g., one installed “on top” of the operating system)—or can alternatively be implemented directly by the operating system of the client device 110B. For example, the application 115 can be a web browser installed on top of the operating system, or can be an application that is integrated as part of the operating system functionality.

In various implementations, the client device 110B (and/or the computing device 110A) can include a user input engine 111 that is configured to detect user input provided by a user of the client device 110B using one or more user interface input devices. For example, the client device 110B can be equipped with one or more microphones that capture audio data, such as audio data corresponding to spoken utterances of the user or other sounds in an environment of the client device 110B. Additionally, or alternatively, the client device 110B (and/or the computing device 110A) can be equipped with one or more vision components that are configured to capture vision data corresponding to images and/or movements (e.g., gestures) detected in a field of view of one or more of the vision components. Additionally, or alternatively, the client device 110B (and/or the computing device 110A) can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110B.

For example, the client device 110B can include a display that displays a plurality of graphical user interface (GUI) elements, such as a first GUI element to receive a first user input/selection of a qualify score (e.g., from a plurality of predefined quality scores, such as “1, 2, 3, 4, and 5” with “1” corresponding to the lowest requirement of quality and “5” being the highest requirement of quality), a second GUI element to receive a second user input/selection of a cost limit (e.g., from a plurality of predefined cost limits, such as “1, 2, 3, 4, and 5” with “1” corresponding to the lowest cost limit and “5” being the highest cost limit), a third GUI element to receive a third user input/selection of a latency tolerance level (e.g., from a plurality of predefined latency tolerance levels such as level 1, level 2, and level 3, within “level 1” corresponding to the lowest level of latency requirement and “level 3” corresponding to the highest level of latency requirement), and/or a fourth GUI element to receive a fourth user input/selection of a safety level (e.g., from a plurality of predefined safety levels, such as “level 1” and “level 2”, with “level 1” being a low level of safety requirement and “level 2” being a high level of safety requirement, e.g., in terms of strength of alignment against producing harmful output).

The plurality of GUI elements can additionally, or alternatively, include other GUI elements such as a fifth GUI element to receive user input/selection of a resilience level, a sixth GUI element to receive user input/selection of a model preference, a seventh GUI element to receive user input/selection of an intent score, etc. However, the present disclosure is not intended to be limiting. For example, in some implementations, the plurality of GUI element can additionally or alternatively include a set of GUI elements to receive user input/selection for mixed selection features. The set of GUI elements can include, for instance, a first mixed-type GUI element that receive user input that selects “prioritize quality” which prioritizes quality over cost (or a different factor such as safety, latency, etc.) and thus selects a generative model that is most likely to meet the submitter's high-quality expectations even if it's costly, “balanced” which balances quality and cost (or a different factor such as safety), or “prioritize cost” which selects the model that is most likely to meet the submitter's low-cost expectations even if it has lower quality.

Optionally, a custom selection features can be updated. For example, a developer of an e-commerce application can set default routing to low cost but switch to medium cost to ensure increased quality.

In some implementations, referring to FIG. 1B, the request generation engine 116 of the computing device 110A can generate a generative model request based on a user query received from the client device 110B (but this is not required). Some instances of a generative model request described herein can be derived from a user query that is formulated based on user input provided by a user (e.g., user R) of the client device 110B and detected via user input engine 111. For example, the user query can be a typed query that is typed via a physical or virtual keyboard, a suggested query that is selected via a touch screen or a mouse, a spoken voice query that is detected via microphone(s) of the client device 110B, or an image query that is based on an image captured by a vision component of the client device 110B.

In some implementations, as described above and referring to FIG. 1A, the request generation engine 116 of the computing device 110A can generate a generative model request without receiving any user query received from the client device 110B. Some instances of a generative model request described herein can be, for instance, formulated based on developer input from a developer of the application 115 (or a system input from the computing device 110A, which may or may not be generated automatically). For example, the application 115 can be a toy-selling application, and in this example, the request generation engine 116 can be configured by a developer of the application 115 to generate (e.g., every Monday, or the first day of every month, etc.) a generative model request that requests a weekly summary (or monthly summary, etc.) of sales information (e.g., total revenue, total cost, shipping costs, inventory, etc.) of items listed via the toy-selling application.

In various implementations, the client device 110B (and/or the computing device 110A) can include a rendering engine 112 that is configured to provide content (e.g., a natural language based response generated by an LLM) for audible and/or visual presentation to a user of the client device 110B using one or more user interface output devices. For example, the client device 110B can be equipped with one or more speakers that enable content to be provided for audible presentation to the user via the client device 110B. Additionally, or alternatively, the client device 110B can be equipped with a display or projector that enables content to be provided for visual presentation to the user via the client device 110B.

In various implementations, the client device 110B (and/or the computing device 110A) can include a context engine 113 that is configured to determine a context (e.g., current or recent context) of the client device 110B and/or of a user of the client device 110B. In some of those implementations, the context engine 113 can determine a context utilizing current or recent interaction(s) via the client device 110B, a location of the client device 110B, profile data of a profile of a user of the client device 110B (e.g., an active user when multiple profiles are associated with the client device 110B), and/or other data accessible to the context engine 113. For example, the context engine 113 can determine a current context based on a current state of a query session (e.g., considering one or more recent queries of the query session), profile data, and/or a current location of the client device 110B. For instance, the context engine 113 can determine a current context of “looking for a healthy lunch restaurant in Louisville, Kentucky” based on a recently issued query, profile data, and a location of the client device 110B. As another example, the context engine 113 can determine a current context based on which application is active in the foreground of the client device 110B, a current or recent state of the active application, and/or content currently or recently rendered by the active application. A context determined by the context engine 113 can be utilized, for example, as all or part of dialog context described herein. A context determined by the context engine 113 can additionally or alternatively be utilized, for example, in supplementing or rewriting a query that is formulated based on user input, in generating an implied query (e.g., a query formulated independent of user input), and/or in determining to submit an implied query and/or to render result(s) (e.g., an LLM generated response) for an implied query.

In various implementations, the client device 110B (and/or the computing device 110A) can include an implied input engine 114 that is configured to: generate an implied query independent of any user input directed to formulating the implied query; to submit a request that includes the implied query, optionally independent of any user input that requests submission of the request; and/or to cause rendering of a response for an implied query, optionally independent of any user input that requests rendering of the response. For example, the implied input engine 114 can use current context, from current context engine 113, in generating an implied query, determining to submit a request that includes the implied query, and/or in determining to cause rendering of a response for the implied query. For instance, the implied input engine 114 can automatically generate and automatically submit an implied query based on the current context. Further, the implied input engine 114 can automatically push a response to the implied query to cause the response to be automatically rendered or can automatically push a notification of the response, such as a selectable notification that, when selected, causes rendering of the response. As another example, the implied input engine 114 can generate an implied query based on profile data (e.g., an implied query related to an interest of a user), submit the query at regular or non-regular intervals, and cause a corresponding response to be automatically provided (or a notification thereof automatically provided).

In some implementations, referring back to FIG. 1A, the example environment 100A can optionally include the computing device 110A, without including the client device 110B. As described previously, the computing device 110A can include, for instance, the request generation engine 116, to generate one or more generative model requests to be processed using a generative model selected from the candidate generative models 150. A generative model request can include a query (e.g., a user query, an implied query, a system query configured by a developer of the application 115, etc.) and/or metadata associated with the query (e.g., recent purchase or transactions of a user of the user query that triggers the generation of a generative model request). For example, if the application 115 is associated with a toy company, the generative model request can include a query (e.g., a system query) seeking a summary of weekly sales for products of the toy company and metadata (e.g., sales information of all or some products of the toy company).

In some implementations, the computing device 110A (and/or the client device 110B), the routing system 120, the generative system 130, and/or the training/fine-tuning system 140 can include one or more memories (or databases) for storage of data and/or software applications, one or more processors for accessing data and executing the software applications, and/or other components that facilitate communication over one or more of the networks 13. In some implementations, one or more of the software applications can be installed locally at the computing device 110A, whereas in other implementations one or more of the software applications can be hosted remotely (e.g., by one or more servers) and can be accessible by the computing device 110A over one or more of the networks 13 (or networks 13A and/or 13B, etc.).

Although aspects of FIG. 1A are illustrated or described with respect to a single computing device 110A, it should be understood that is for the sake of example and is not meant to be limiting. For example, one or more additional computing devices (e.g., 110B in FIG. 1B) can also implement the techniques described herein. For instance, the computing device 110A, the one or more additional computing devices, and/or any other computing devices can form an ecosystem of devices that can employ techniques described herein. These additional client devices and/or computing devices may be in communication with the computing device 110A (e.g., over the network(s) 13). As another example, a given client device can be utilized by multiple users in a shared setting (e.g., a group of users, a household).

Further referring to FIG. 1A, the routing system 120 is illustrated as including a load engine 124, and/or a selection engine 126. In some implementations, one or more of the engines 124 and/or 126 can be omitted. In some implementations, one or more additional engines can be included in the routing system 120. For example, referring to FIG. 1B, the routing system 120 can additionally include a request features engine 122 and/or a constraints engine 128. The constraints engine 128 can determine or retrieve a set of constraints customized by a query-submitting entity (or a request-submitting entity). The set of constraints can include (or be derived from), for instance, the aforementioned qualify score, the cost limit (e.g., the maximum number of tokens allowed for processing per month), the latency tolerance level, the safety level, the resilience level, the model preference, and/or the intent accuracy level, etc.

In some implementations, optionally, the request features engine 122 can, in response to receiving a request (e.g., a generative model request from the computing device 110A or other device), generate or retrieve request feature(s) for the request. The request feature(s) can include query feature(s) of a query included in the request, such as query features that are based on term(s) of a natural language query included in the request. The request feature(s) can additionally or alternatively include metadata associated with the query, such as dataset(s) or file(s) indicating weekly sales, historical price data, transaction records, market reports, etc.

The request features can additionally or alternatively include context features, such as context features associated with a transaction, or context features that are based on prior request(s) and/or prior response(s) of an ongoing dialog in which the request is provided. One or more of the context features, the prior response(s), and/or the prior request(s) can be included as part of the request (e.g., generated by the context engine 113). Additionally or alternatively, one or more of the context features, the prior response(s), and/or the prior request(s) may not be included as part of the request, but the request features engine 122 can retrieve them (e.g., from remote storage accessible by the routing system 120) using the request (e.g., using an attribute identifier of the request). The request features can additionally or alternatively include attribute feature(s) associated with the computing device 110A and/or a user (e.g., user R, a developer of the application 115, etc.) that initiated the request. For example, the request can include an attribute identifier and the request features engine 122 can generate attribute feature(s) using the attribute identifier.

In some implementations, the load engine 124 can optionally be included in the routing system 120 and be configured to determine a current server load, which can be a measured or expected/predicted server load. The current server load characterizes a magnitude of computational resource utilization being experienced by one or more (e.g., all) of the generative system 130. The load engine 124 can utilize one or more techniques in determining the current server load. For example, the load engine 124 can communicate with the generative system 130 and obtain, from the generative system 130, the current server load directly or current metric(s) that can be utilized by the load engine 124 to determine the current server load. As another example, the load engine 124 can predict the current server load based on a quantity of recent requests processed by the routing system 120 and, optionally, the selections made by the routing system 120 for those recent requests. For instance, the load engine 124 can predict a higher current server load if 1,000 requests were processed by the routing system 120 in the last second as compared to if only 500 requests were processed by the routing system 120 in the last second. Also, for instance, the load engine 124 can predict a higher current server load if 1,000 requests were processed by the routing system 120 in the last second and 33% were selected for handling by the least computationally efficient of the candidate generative models 150 as compared to if 1,000 requests were processed by the routing system 120 in the last second and only 5% were selected for handling by the least computationally efficient of the candidate generative models 150.

The selection engine 126 utilizes a generative model request and a set of constraints customized for the generative model request (and/or the request features determined for the the generative model request), to select which, if any, of the multiple candidate generative models 150 should be utilized in responding to the the generative model request. The selection engine 126 can optionally or additionally utilize the current load, determined by the load engine 124, in selecting which, if any, of the multiple candidate generative models 150 should be utilized in responding to the request. For example, the selection engine 126 can, for a particular generative model request submitted by a first submitting entity, select only LLM 150A for utilization in responding to the particular generative model request from the first submitting entity and can, for the same particular generative model request submitted by a second submitting entity, select only LLM 150B for utilization in responding to the particular generative model request from the second submitting entity. The differing selections can be based on considering differing a first set of constraints customized by the first submitting entity (and/or first request features) and a second set of constraints customized by the second submitting entity (and/or second request features)—and/or based on considering differing current loads at a first time of the first request and a second time of the second request.

As one particular example, the selection engine 126 can process a generative model request and a set of constraint customized by a submitting entity of the generative model request, to generate a first measure for LLM 150A, a second measure for LLM 150B, . . . , and an K^{th} measure for LLM 150K, and optionally additional measure(s) for additional LLM(s) (e.g., if subsequently being included in the candidate generative models 150) and/or other generative models (indicated generally by the vertical ellipsis in FIG. 1A). Each of the generated measures characterizes a corresponding probability of generating a desired response to the generative model request using a correspondingly selected generative model. The selection engine 126 can then select only one (or even none in some situations) of the candidate generative models based on the generated measures, optionally also considering current server load as determined by the load engine 124.

In some implementations and/or for some requests, the selection engine 126 utilizes ML model(s) 152 (e.g., a trained neural network model) in selecting from among the candidate generative models 150. The ML model(s) 152 (“routing model(s)”) utilized by the selection engine 126 may be more computationally efficient than at least some of the candidate generative models 150. In some of those implementations, the selection engine 126 processes at least the set of constraints customized for a generative model request and/or the generative model request, using the ML model(s) 152, to generate output that indicates, for each of the candidate generative models 150, a corresponding probability of generating a desired response. For example, the output can include a first probability for LLM 150A, a second probability for LLM 150B, . . . , and an K^{th} probability for LLM 150K, etc. The measures, considered by the selection engine 126, can be based on (e.g., strictly conform to) the corresponding probabilities.

The selection engine 126 can provide, to the generative system 130 (or one of the generative systems if there is more than one generative system), an indication of the selected generative model. The generative model request can also be provided, in conjunction with the indication of the selection, to one of the generative system(s) 130 by the routing system 120 or by the computing device 110A directly.

The generative system 130, in response to receiving a generative model request and an indication of a selected generative model, processes the generative model request using the selected generative model to generate generative output. The generative system 130 identifies the selected generative model selected for the generative model request based on receiving the indication of the selected generative model in conjunction with the generative model request, and can utilize the selected generative model without utilizing any other available generative model in processing the generative model request. Further, the generative system 130 generates a response, based on the generative output, and causes the response to be rendered at the computing device 110A (or the client device 110B, etc.) and to be rendered responsive to the generative model request. For example, the generative system(s) 130 can transmit the response to the computing device 110A (or the client device 110B) directly for rendering, or can transmit the response to the routing system 120, which then transmits the response to the computing device 110A for rendering.

As a particular example, the generative system 130 can, in response to a first generative model request and an indication of LLM 150A being selected from the candidate generative models 150, process the first generative model request using only LLM 150A (i.e., without using other LLMs such as LLM 150B˜150K) to generate first LLM output, generate a first response based on the first LLM output, and cause the first response to be rendered by the computing device 110A (or the client device 110B) in response to the first generative model request. Further, the generative system 130 can, in response to a second generative model request and an indication of LLM 150B being selected, process the second request using only LLM 150B to generate second LLM output, generate a second response based on the second LLM output, and cause the second response to be rendered by the computing device 110A (or the client device 110B) in response to the second generative model request. Notably, in generating the first response, the generative system 130 can utilize the LLM 150A without any utilization of any other of the candidate generative models 150. Likewise, in generating the second response the generative system 130 can utilize the LLM 150B without any utilization of any other of the candidate generative models 150.

The training/fine-tuning system 140 can be used to train or fine-tune the ML model(s) 152 that can be utilized by the selection engine 126 in generating probabilities and/or other measures or indications that the selection engine 126 utilizes in selecting a generative model from the candidate generative models 150. A non-limiting example of the training system 140 can be found in FIG. 1B includes a training/fine-tuning engine 142, a measure engine 144, a ground truth (GT) label engine 146, and/or a training instance engine 148.

In some implementations, the training instance engine 148 can work in cooperation with the measure engine 144 and the GT label engine 146 in generating training instances that each include (a) training instance input that includes one or more constraints (such as a customized quality score, a customized cost limit, a customized latency tolerance level, a customized safety level, a customized resilience level, a customized model preference, a customized intent score, etc.) for a generative model request and/or request features for the generative model request, and (b) ground truth classification labels that are each for a corresponding one of the candidate generative models 150. The training engine 142 can then utilize the training instances, generated by the training instance engine 148, in training the ML model(s) 152.

In generating a training instance, the training instance engine 148 can identify, from database 154A, a request and a ground truth response for the request. For example, the ground truth response for the request can be one that was formulated by a human and/or that was verified by human rater(s) as being an appropriate response to the request. The measure engine 144 can, for each of the generative models 150, process the identified generative model request using the generative model to generate corresponding output. For example, the measure engine 144 can process the generative model request using LLM 150A to generate first LLM output, process the generative model request using LLM 150B to generate second LLM output, etc. Further, the measure engine 144 can, for each of the generative models 150, generate a measure for the generative model based on comparing the corresponding output to the ground truth response for the generative model request. For example, the measure engine 144 can generate a first measure for the LLM 150A based on comparing the first LLM output to the ground truth response, can generate a second measure for the second LLM 150B based on comparing the second LLM output to the ground truth response, etc.

Further, the GT label engine 146 can generate ground truth classification labels, for the training instance, as a function of all of the measures generated by the measure engine 144. For example, the GT label engine 146 can generate soft ground truth classification labels that are based on a normalization of all of the measures or can generate hard ground truth classification labels based on all of the measures. In some implementations, the GT label engine 146 determines the ground truth classification labels further based on one or more of the aforementioned customized constraints or other factors (e.g., computational efficiencies). For example, for more computationally efficient generative model(s), the GT label engine 146 can boost the soft label magnitude and/or boost the likelihood of a hot/positive hard label being assigned. Also, for example, for less computationally efficient generative model(s), the GT label engine 146 can additionally or alternatively decrease the soft label magnitude and/or decrease the likelihood of a hot/positive label being assigned. It is noted that, in implementations where the GT label engine 146 determines the ground truth classification labels based on corresponding computational efficiency measures, the ML model(s) 152 will be trained to generate output that accounts for and biases toward more computationally efficient generative model(s). This can obviate the need for the selection engine 126 to, when making a selection based on output generated based on processing a generative model request and a set of constraints (customized by a submitting entity of the generative model request) using the trained ML model(s) 152, separately consider one or more constraints placed by the submitting entity with respect to selection of generative model(s). For example, since the ML model(s) 152 are trained to account for and bias toward one or more particular generative models from the candidate generative models 150 based on the set of constraints specific to a submitting entity, the selection engine 126 can bypass performing post-processing of output, generated using the trained ML model(s) 152, to bias toward more the one or more particular generative models.

The training instance engine 148 can then generate a training instance that includes, as training instance input, a generative model request and/or one or more customized constraints (e.g., a customized quality score, a customized cost limit, a customized latency tolerance level, a customized safety level, a customized resilience level, a customized model preference, and/or a customized intent accuracy level) for the generative model request and that includes, as training instance output, the ground truth classification labels generated by the GT label engine 146. As referenced above, the training engine 142 can train or fine-tune the ML model(s) 152 based on such a generated training instance, as well as many additional (e.g., thousands, hundreds of thousands) similarly generated training instances.

In some implementations, the training system 140 can include additional or alternative components, and/or can access one or more training instance databases in training the ML model(s) 152. In some implementations, the example environment (e.g., 100A or 100B) can additionally, or alternatively, include a fine-tuning system 160 separate from the training system 140 to fine-tunes the ML models 152 or a portion thereof, e.g., based on one or more customized constraints provided by developer(s) of the application 115 (or a different application, etc.).

Techniques described in various implementations enable selection of a generative model from the candidate generative models 150 for processing of a generative model request (derived from a system query or user query) based on constraints customized by a submitting entity that submits the generative model request, without testing each of the candidate generative models 150 using the generative model request. This saves time and computational resources associated with testing of each candidate generative model, and reduces the latency in generating a response for the query (or the request), while ensuring that the response generated for the query is as desired by a submitting entity of the generative model request (e.g., meeting the constraints specific to the submitting entity). The techniques described herein, for instance, train or fine-tune one or more ML models 152 in taking into consideration customized constraints in selecting a single generative model from the candidate generative models 150, where the customized constraints can include, but are not limited to, a quality score/factor, a cost factor (e.g., cost limit), a latency factor (e.g., latency limit, or latency level), and/or a safety factor (e.g., safety level), or other factors such as a resilience score. Using techniques described herein, a generative model satisfying the customized constraints can be selected and be further utilized to process a generative model request submitted by a submitting entity of the generative model request.

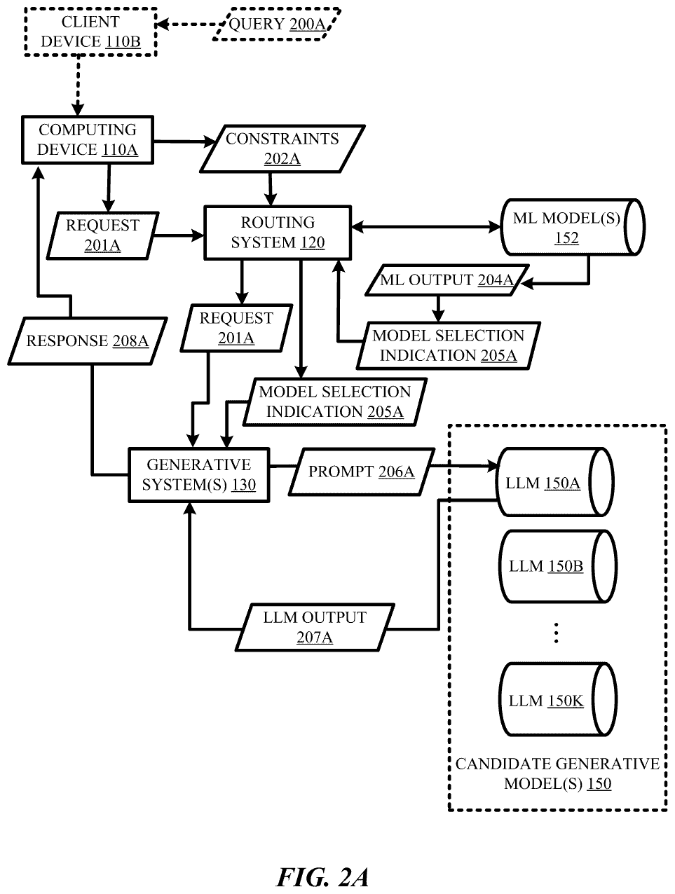

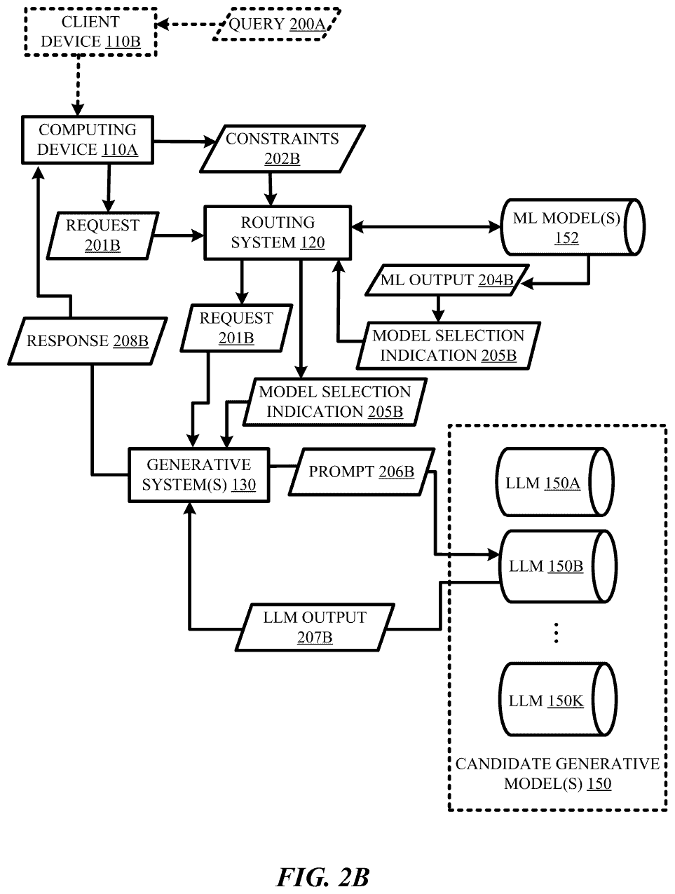

Turning now to FIG. 2A, an example of interactions between components of FIG. 1A (or 1B), is illustrated that can occur in selecting, in response to receiving a request 201A and from among multiple candidate generative models 150, generative model 150A for utilization in generating a response 208A to the request 201A.

In FIG. 2A, a computing device 110A submits a generative model request 201A (shortly “request 201A”) and/or an indication (e.g., an identity such as name, symbol, etc.) of a submitting entity that submits the request 201A. In some implementations, the computing device 110A can submit the request 201A, e.g., in response to receiving a query 200A from a client device 110B, where the query 200A can be a user query received from a user of the client device 110B. But this is not required. For example, the computing device 110A can submit the request 201A automatically (e.g., daily, weekly, bi-weekly, etc.), without receiving any signal or query from the client device 110B.

The routing system 120 receives the request 201A and/or the indication of the submitting entity that submits the request 201A. In some implementations, the routing system 120 can retrieve one or more constraints customized by the submitting entity that submits the request 201A. The routing system 120 can retrieve the one or more constraints 202A in response to receiving the request 201A, periodically, or prior to receiving the request 201A, etc. For example, in some implementations, the routing system 120 can cause the computing device 110A to display one or more of the aforementioned GUI elements to receive user input/selection of constraints such as a quality score (e.g., 1˜5), cost limit, latency tolerance level, safety level, and/or resilience level, for each submitting entity.

In some implementations, the constraints specific to each submitting entity can be stored in a customized constraint database, where different customized constraint(s) can be stored for different submitting entities. For example, the customized constraint database can include a first entry for a first submitting entity (e.g., a toy store) and a second submitting entry (e.g., crypto exchange company) that is different from the first submitting entity. In this example, the first entry stores a first set of constraints (e.g., a safety level of 5, which corresponds to the highest safety level, and/or other constraints such as a qualify score of 3 indicating neural requirement of quality) customized by the first submitting entity, and the second entry stores a second set of constraints (e.g., a quality score of 5, which corresponds to the highest quality requirement) customized by the second submitting entity. Optionally, a submitting entity can update the customized constraints, e.g., by re-selecting user input/constraints for one or more of the aforementioned GUI elements, and the set of constraints stored in the customized constraint database for the submitting entity can be correspondingly updated. Optionally, the submitting entity can set an expiration date for the customized constraints specific to the submitting entity, but this is not required. Using the customized constraint database, in some implementations, the routing system 120 can retrieve one or more customized constraints for a submitting entity, based on an indication of the submitting entity (that identifies the submitting entity) and in response to receiving a generative model request submitted by the submitting entity.

In some implementations, the routing system 120 can process the one or more customized constraints 202A and/or the request 201A using the ML model(s) 152 to generate ML output 204A indicating a selection of an LLM from the LLMs 150A˜150K. In one example, the ML output 204A includes a vector of probabilities [0.49; 0.29; . . . ; 0.09], where “0.49” corresponds to LLM 150A, “0.29” corresponds to LLM 150B, “0.09” corresponds to LLM 150K, and “ . . . ” corresponds to one or more probabilities for one or more other (unillustrated) of the candidate generative models 150. In some implementations, the ML model(s) 152 can include a single ML model that has input dimensions that correspond to the dimensions of the request features 203A and output dimensions that conform to the dimensions of the vector of probabilities. For instance, the single ML model can have a softmax layer, as a final layer, that is used to generate the vector of probabilities.

The routing system 120 uses the ML output 204A to select LLM 150A for utilization in generating a response to the request 201A. For instance, if the probability of “0.49” (which corresponds to LLM 150A) is greater than the probability of “0.29” (which corresponds to LLM 150B), the routing system 120 selects the LLM 150A over the LLM 150B. As a non-limiting example for FIG. 2A, the submitting entity of the request 201A can be a toy store that customizes the constraint(s) 202A to include (or only include) a safety level of “5” which indicates the highest level of safety and thus requires processing of the request 201A using more sophisticated generative model. In this non-limiting example, the LLM 150A can be selected based on including a greater amount of parameters, even if it being less computationally efficient than the LLM 150B. In this example, the routing system 120 selects the LLM 150A over the LLM 150B based on the fact that the one or more constraints customized by the submitting entity of the request 201A define a high safety level. In some implementations, the ML output 204A can be processed to determine an indication that indicates which LLM from the LLMs 150A˜150K is selected. For instance, continuing with the example above, the ML output 204A that includes a vector of probabilities [0.49; 0.29; . . . ; 0.09] can be processed to determine a model selection indication (shortly as “indication”) 205A indicating that LLM 150A is selected to process the request 201A.

In some implementations, the ML model(s) 152 may have been trained with ground truth labels that take into account a quality and a cost of the candidate generative models. In some implementations, optionally, for each submitting entity, the ML model(s) 152 can be respectively fine-tuned with ground truth labels that further consider a respective set of customized constraints that may alter a default quality score or that include an additional constraint that is in addition to the quality and the cost, such as a safety level. In this case, when receiving a particular request from a submitting entity, the routing system 120 can access a portion of the ML model(s) 152 that are fine-tuned to take into consideration the corresponding set of constraints customized by the submitting system, to generate the model selection indication 205A.

In some implementations, referring to FIG. 2A, the routing system 120 transmits the request 201A and the model selection indication 205A (e.g., that indicates a selection of the LLM 150A) to one of the generative system(s) 130. In response, the one of the generative system(s) 130 processes a prompt 206A (derived from the request 201A) using the selected LLM 150A to generate LLM output 207A. Further, the one of the generative system(s) 130 generates a response 208A based on the LLM output 207A, and transmits the response 208A to the computing device 110A. Notably, the one of the generative system(s) 130 utilizes the LLM 150A without utilization of any other of the candidate generative models 150. Transmitting the response 208A to the computing device 110 causes the computing device 110A (or in some cases, the client device 110B) to render the response responsive to the request 201A.

Turning now to FIG. 2B, another example of interactions between components of FIG. 1A or 1B, is illustrated that can occur in selecting, in response to receiving a different request 201B and from among multiple candidate generative models 150, a different particular generative model 150B to utilize in generating a different response to the different request.

In FIG. 2B, the computing device 110A submits the request 201B. The routing system 120 receives the request 201B, retrieves a set of constraints 202B based on an indication (e.g., identifier) of a submitting entity that submits the request 201B, and processes the request 201B and the set of constraints 202B using the ML model(s) 152 to generate ML output 204B. The set of constraints 202B can be different from the set of constraint 202A as the submitting entity that submits the request 201B can be different from the submitting entity that submits the request 201A. But this is not required, for instance, the set of constraints 202B can still be different from the set of constraint 202A even if it's the same submitting entity that submits the request 201B as well as the request 201A. In the example of FIG. 2B, the ML output 204B may include a vector of probabilities [0.15; 0.50; . . . ; 0.10], where “0.15” corresponds to LLM 150A, “0.50” corresponds to LLM 150B, “0.10” corresponds to LLM 150K, and “ . . . ” corresponds to one or more probabilities for one or more other (unillustrated) of the candidate generative models 150. The ML output 204B can be optionally processed to determine a model selection indication 205B indicating that LLM 150B is selected for processing of the request 201B.

The routing system 120 uses the ML output 204B (or the model selection indication 205B) to select LLM 150B for utilization in generating a response 208B to the request 201B. As a non-limiting example of FIG. 2B, the submitting entity of the request 201B can be a small business entity that customizes the constraint(s) 202B to include (or only include) a cost limit of “1” or “2” which indicates a high level of cost-saving requirement for responses generated for requests submitted by the small business entity. In this non-limiting example, the LLM 150B can be selected based on including less parameters, being more computational efficient, and therefore cost less than the LLM 150A. In this example, the routing system 120 selects the LLM 150B over the LLM 150A based on the fact that the constraints 202B customized by the submitting entity of the request 201B define a low cost limit.

The routing system 120 transmits the request 201B and the model selection indication 205B to one of the generative system(s) 130. In response, the one of the generative system(s) 130 processes the request 206B using the LLM 150B to generate LLM output 207B. Further, the one of the generative system(s) 130 generates a response 208B based on the LLM output 207B, and transmits the response 208B to the computing device 110. Notably, the one of the generative system(s) 130 utilizes the LLM 150B without utilization of any other of the candidate generative models 150. Transmitting the response 208B to the computing device 110 causes the computing device 110A (or the client device 110B) to render the response 208B responsive to the request 201B.

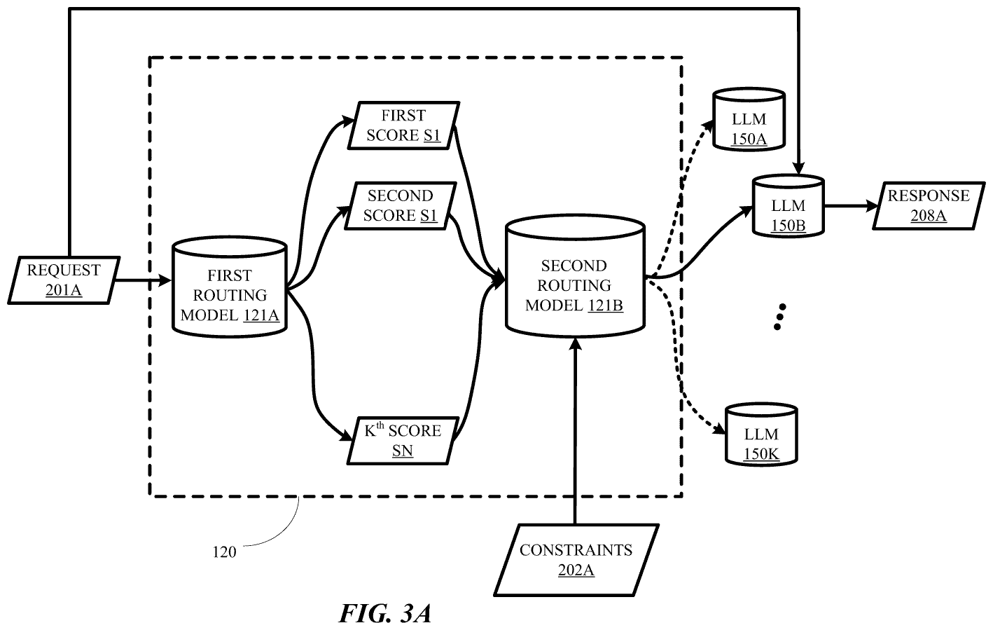

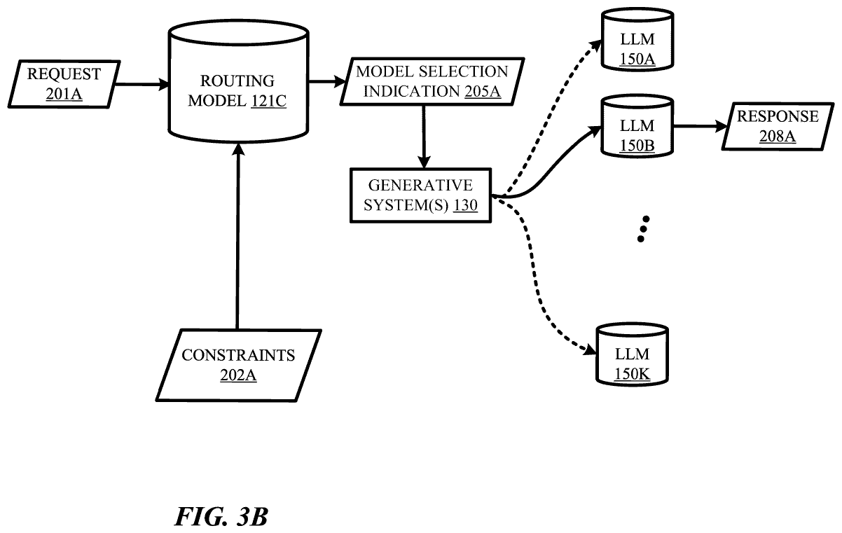

Turning now to FIG. 3A and FIG. 3B, where a two-component routing system is illustrated in FIG. 3A and a single-component routing system is illustrated in FIG. 3B. As shown in FIG. 3A, the routing system 120 can include a first routing model 121A (sometimes referred to as a “static model router”) and a second routing model 121B (e.g., sometimes referred to as a “dynamic selector model”). The first routing model 121A can be, or can include, a neural network trained or fine-tuned to process the request 201A (derived from a system query or a user query) as input, to generate a first routing model output indicating a set of selection scores (first score_S1, second score_S2, . . . , K^{th} score_SK). Each selection score can correspond to a respective generative model from a set of generative models (e.g., generative model_1, generative model_2, . . . , generative model_K) that the routing system 120 can access (e.g., directly or indirectly via the generative system 130, etc.).

The first routing model output (or the set of selection scores) and a set of constraints 202A can be processed as input using the second routing model 121B, to generate a second model output indicating a selection of a generative model (e.g., LLM 150B) from the set of generative models (e.g., generative model_1, generative model_2, . . . , generative model_K) available to the routing system 120. The request 201A can then be processed using the selected generative model (e.g., LLM 150B), to generate a generative model output from which the response 208A is derived. The response 208A can be transmitted and be received by the submitting entity of the request 201A.

The set of constraints 202A can be customized by the submitting entity of the request 201A. In other words, when the submitting entity of the request 201A submits a different set of constraints (that are different from the set of constraints 202A), a different generative model (e.g., LLM 150A instead of LLM 150B) may be selected to process the request 201A submitted by the submitting entity (that customizes the set of constraints as well).

In some implementations, as shown in FIG. 3B, the routing system 120 can include a single routing model 121C. The single routing model 121C can be trained or fine-tuned to process the request 201A submitted by a submitting entity and a set of constraints 202A customized by the submitting entity (or a representative thereof) as input, to generate a routing model output reflecting the model selection indication 205A. The routing system 120 and/or the generative system 130 can forward the request 201A (e.g., to LLM 150B) based on the model selection indication 205A (e.g., indicating that LLM 150B is selected for request processing). The request 201A can then be processed using a selected generative model (e.g., LLM 150B), to generate the response 208A, as depicted in FIG. 3B.

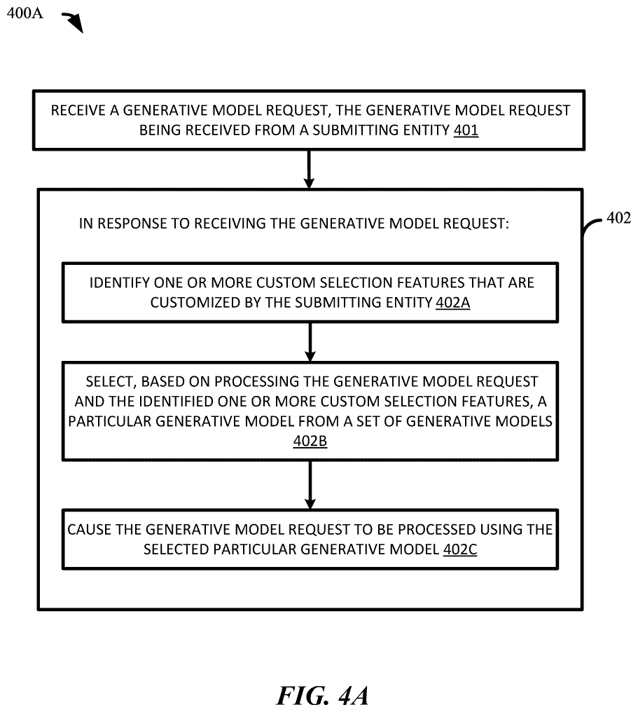

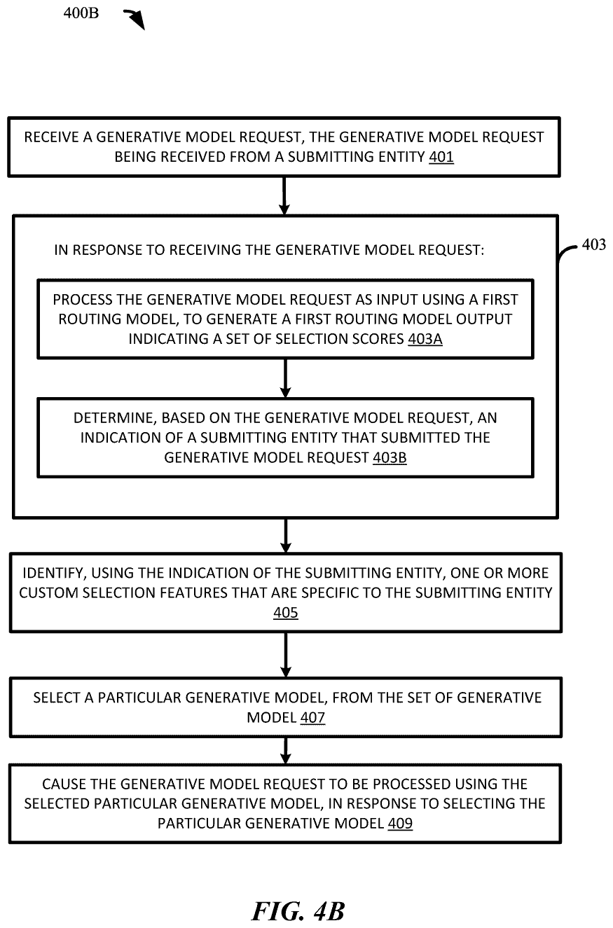

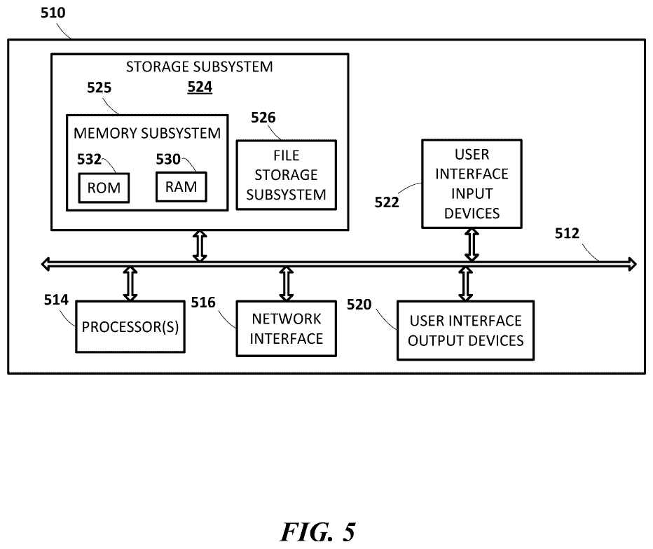

Turning now to FIG. 4A, a flowchart is depicted that illustrates an example method 400A of selecting, in response to receiving a request and from among multiple candidate generative models with differing computational efficiencies, none, one, or multiple generative models to utilize in generating a response to the request. For convenience, the operations of the method 400A are described with reference to a system that performs the operations. This system of the method 400A includes one or more processors, memory, and/or other component(s) of computing device(s) (e.g., computing device 110A of FIG. 1, client device 510 of FIG. 5, one or more servers, and/or other computing devices). Moreover, while operations of the method 400A are shown in a particular order, this is not meant to be limiting. One or more operations may be reordered, omitted, and/or added.

In various implementations, at block 401, the system receives a generative model request, the generative model request being received from a submitting entity (e.g., a third-party application). The generative model request can be, but does not necessarily need to be, derived from a user query. For example, the generative model request can include a natural language request to draft an email (or other content or file), to summarize a document, or identify key information in a dataset. Or, the generative model request can include a natural language request to resolve a customer inquiry, and/or include additional information or data such as an identifier (or membership status, such as “gold membership” or “silver membership” of a user query from which the generative model request is derived. Descriptions of the generative model request herein are not meant to be limiting.

In various implementations, at block 402, the system performs one or more actions in response to receiving the generative model request. For example, in some of the various implementations, the system can identify one or more custom selection features that are specific to (e.g., customized by) the submitting entity (block 402A); select, based on processing the generative model request and the identified one or more custom selection features, a particular generative model from a set of generative models (block 402B); and cause the generative model request to be processed using the selected particular generative model (block 402C).

In some of the various implementations, the system selects the particular generative model from the set of generative models by: processing the generative model request and the identified one or more custom selection features, using one or more routing models, to generate a model selection indication that indicates the particular generative model being selected; and selecting the particular generative model based on the model selection indication that indicates the particular generative model being selected.

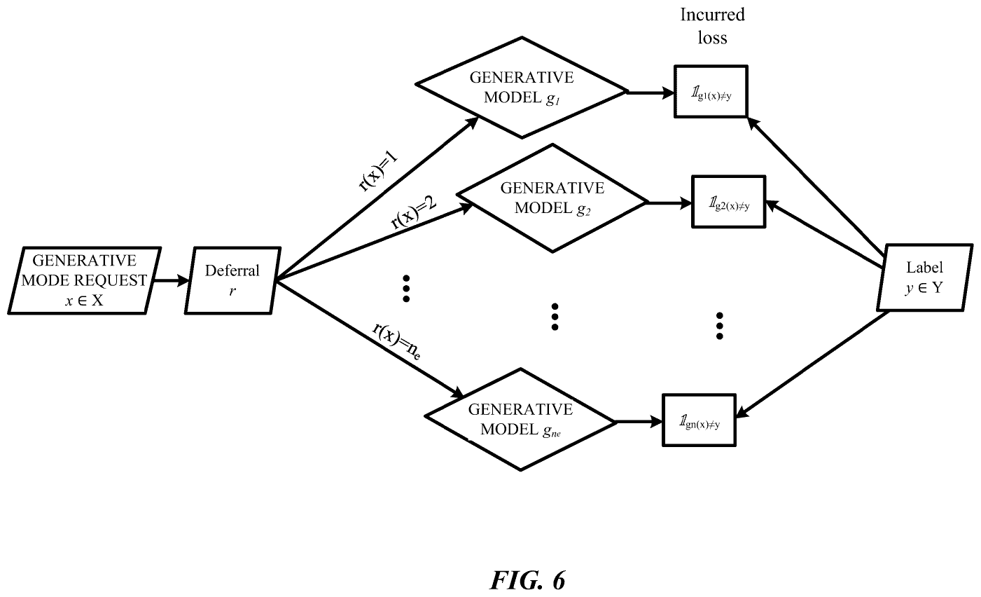

In some of the various implementations, the system processes the generative model request and the identified one or more custom selection features, using the one or more routing models, to generate the model selection indication by: processing the generative model request as input, using a trained or fine-tuned routing model, to generate an model selection indication that indicates the particular generative model being selected. In some implementations, the trained (or fine-tuned) routing model can be trained (or fine-tuned) to select a generative model from a set of generative models based on minimizing a deferring loss function Ldef (r, x, y), where the deferring loss function Ldef (r, x, y) (also referred to as a “system loss function”) can be expressed as follows (which is illustrated in view of FIG. 6):

$$\begin{matrix}{L}_{def} ( r , x , y ) = {\sum }_{j = 1}^{{n}_{e}} & {c}_{j} ( x , y ) \cdot {l}_{r ( x ) = j}\end{matrix} \qquad equation ( 1 )$$

In the equation (1) above, “x” represents a training generative model request that belongs to a training input space X, “y” is a ground truth label belonging to a label set Y having a set of n ground truth labels (e.g., Y={1, 2, . . . , n}, n≥2). The label set Y can be augmented with nₑ additional labels {n+1, n+2, . . . , n+nₑ} corresponding to a total number of nₑ generative models (g₁, g₉₂, . . . , gₙ_{ₑ}). Further, r(x) is a routing function dependent at least on x, l is an indicator function/term, and cⱼ(x, y) is a cost function corresponding to an overall cost of deferring to a generative model gⱼ(1≤j≤nₑ) from a set of generative models {g₁, g₂, . . . , gₙ_{ₑ})}. The cost function cⱼ(x, y) can dependent on the training generative model request and be label-dependent.

One non-limiting example of the cost function cⱼ(x, y) can be as follows:

$${c}_{j} ( x , y ) = {α}_{j} \cdot Q ( {g}_{j} ( x ) , y ) + {β}_{j} \qquad equation ( 2 )$$

In equation (2), gⱼ(x) represents prediction made by generative model gⱼ for the generative model request x, where gⱼ(x)=arg max_{y∈Y}gⱼ(x, y). Further, βⱼ corresponds to the inference cost (e.g., hardware serving price) of the generative model gⱼ and/or other custom selection feature(s) such as safety score (resilience score, throughput score, etc.), αⱼ controls trade-off between the inference cost and the quality of the generative model gⱼ, and Q(gⱼ(x), y) can be any applicable quality measure such as a classification loss, e.g., Q(gⱼ (x),y)=l_{gj(x)≠y}, which is an incurred loss generated by querying a respective generative model g j from the set of generative models.

In some of the various implementations, the system processes the generative model request and the identified one or more custom selection features, using the one or more routing models, to generate the model selection indication by: processing the generative model request as input, using a first routing model, from the one or more routing models, to generate a first model output indicating a set of selection scores each for a respective generative model from the set of generative models; and processing the first model output and the identified one or more custom selection features, to generate the model selection indication that indicates the particular generative model being selected.

In some of the various implementations, the system processes the first model output and the identified one or more custom selection features, to generate the model selection indication by: processing the first model output and the identified one or more custom selection features as input, using a second routing model (different from the first routing model), to generate a second model output reflecting the model selection indication that indicates the particular generative model being selected.

In some of the various implementations, the first routing model includes a first neural network, and the second routing model includes a second neural network different from the first neural network.

In some of the various implementations, the one or more custom selection constraints include a safety constraint. Optionally, the safety constraint is determined based on user selection of a graphical user interface (GUI) element that is rendered via a display to receive a desired safety level in processing the generative model request, from a plurality of predefined safety levels.

In some of the various implementations, additionally, or alternatively, the one or more custom selection constraints include a maximum cost limit for processing the generative model request. In some of the various implementations, additionally, or alternatively, the one or more custom selection constraints include a throughput requirement. The one or more custom selection constraints, however, are not limited to descriptions herein, and can additionally or alternatively include other factors or scores such as a latency level described elsewhere of this disclosure.

In some implementations, a routing score considering the custom selection feature(s) for a respective generative model from the set of generative models can be calculated as follows:

$$Routing score = a Quality + b Cost + c Latency ,$$

wherein a, b, and c are weighting factors (e.g., in the form of matrices) adjusted based on fine-tuning the routing model to take into consideration a set of custom selection constraints (quality, cost, and latency). For example, the weighting factors a, b, and c can be adjusted based on fine-tuning the second routing model (e.g., the dynamic selector model) using a submitter-defined example that shows a selection of a corresponding generative model for processing a generative model request based on one or more submitter-defined selection features.

In some implementations, the routing score can be calculated as follows:

$$Routing score = a Quality + b Cost + c Safety ,$$

wherein a, b, and c are adjustable weighting factors adjusted based on fine-tuning the single routing model to take into consideration a set of custom selection constraints (quality, cost, and safety).

In some implementations, the routing score can be calculated as follows:

$$Routing score = a Quality + b Cost + c Safety + d Latency ,$$

wherein a, b, c, and d are weighting factors adjusted based on fine-tuning the single routing model to take into consideration a set of custom selection constraints (quality, cost, Safety, and Latency). The way the routing score is calculated is not limited to descriptions herein.

In some of the various implementations, the one or more routing models includes a single routing model fine-tuned (e.g., via low-rank adaptation) based on the one or more custom selection constraints specific to the submitting entity. In this case, the system processes the generative model request and the identified one or more custom selection features, using the one or more routing models, to generate the model selection indication by: adapting the single routing model based on the one or more custom selection constraints specific to the submitting entity; processing the generative model request as input, using the adapted single routing model, to generate a routing model output reflecting routing score(s) indicating a selection of a particular generative model from the set of generative models.

Turning now to FIG. 4B, a flowchart is depicted that illustrates an example method 400B of selecting, in response to receiving a request and from among multiple candidate generative models with differing computational efficiencies, none, one, or multiple generative models to utilize in generating a response to the request. For convenience, the operations of the method 400B are described with reference to a system that performs the operations. This system of the method 400B includes one or more processors, memory, and/or other component(s) of computing device(s) (e.g., computing device 110A of FIG. 1, client device 510 of FIG. 5, one or more servers, and/or other computing devices). Moreover, while operations of the method 400B are shown in a particular order, this is not meant to be limiting. One or more operations may be reordered, omitted, and/or added.

In various implementations, at block 401, the system receives a generative model request, the generative model request being received from a submitting entity.

In some of the various implementations, at block 403, in response to receiving the generative model request, the system processes the generative model request as input using a first routing model, to generate a first routing model output indicating a set of selection scores (block 403A), and determines, based on the generative model request, an indication of a submitting entity that submitted the generative model request (block 403B). Each selection score, in the set of selection scores, can correspond to one of a set of generative models.

In some of the various implementations, at block 405, the system identifies, using the indication of the submitting entity, one or more custom selection features that are specific to the submitting entity.

In some of the various implementations, at block 407, the system selects a particular generative model, from the set of generative models, wherein selecting the particular generative model is based on the one or more custom selection features and the set of selection scores. The one or more custom selection features are utilized in the selecting in response to the one or more custom selection features being specific to the submitting entity that submitted the generative model request.

In some of the various implementations, at block 409, the system causes the generative model request to be processed using the selected particular generative model, in response to selecting the particular generative model.

In some of the various implementations, the system selects the particular generative model by: processing the one or more custom selection features and the set of selection scores as input, using a second routing model, to generate a model selection indication reflecting a selection of the particular generative model from the set of generative models; and selecting the particular generative model based on the model selection indication.

In some of the various implementations, the set of generative models include a first generative model and a second generative model that is different from the first generative model, and wherein the set of selection scores include a first selection score determined for the first generative model and a second selection score determined for the second generative model.

In some of the various implementations, the one or more custom selection constraints include a safety constraint. In some of the various implementations, the safety constraint is determined based on user selection of a graphical user interface (GUI) element that is rendered via a display to receive a desired safety level in processing the generative model request, from a plurality of predefined safety levels (e.g., safety level 1 indicating a low safety requirement, safety level 2 indicating an intermediate safety requirement, and safety level 3 indicating a high safety requirement).

In some of the various implementations, additionally, or alternatively, the one or more custom selection constraints include a maximum cost for processing the user query. In some of the various implementations, additionally, or alternatively, the one or more custom selection constraints include a throughput requirement.

In some of the various implementations, the method further includes: receiving an update to the cloud storage system that adds a third generative model to the cloud storage system; and fine-tuning the loss function to select, for a second given user query, a second particular generative model from the updated set of generative models that balances a cost of processing the second given user query and a quality of the second particular generative model. In some of the various implementations, the second particular generative model is different from the first particular generative model.

In various implementations, another method implemented using one or more processors is provided. The method includes: receiving a user query, e.g., at a cloud storage system. The cloud storage system can include a set of generative models. The set of generative models can have different configurations, different amounts of parameters, and/or be trained or fine-tuned using different sets of training instances. It is noted that while the method herein relates to “user query”, the method described herein can be applied to select a generative model from the set of generative models in response to receiving a system request (e.g., a generative mode request derived from a system query). The present disclosure is not intended to be limiting.

In various implementations, the method further includes: in response to receiving the user query, processing the user query as input using a first routing model, to generate a first routing model output indicating a set of selection scores, where each selection score, from the set of selection scores, corresponds to one of a set of generative models that are hosted at the cloud storage system.

In various implementations, the method further includes: processing, the set of selection scores and one or more custom selection constraints, as input using a second routing model, to generate a second routing model output indicating a selection of a particular generative model, from the set of generative models at the cloud storage system.

In various implementations, the method further includes: processing the user query as input, using the particular generative model, to generate a model output reflecting a response to the user query.

In some of the various implementations, the set of generative models include a first generative model and a second generative model that is different from the first generative model, and wherein the set of selection scores include a first selection score determined for the first generative model and a second selection score determined for the second generative model.

In some of the various implementations, the first routing model is a neural network trained using a loss function to select, for a first given user query, a first particular generative model from the set of generative models that balances a cost of processing the first given user query and a quality of the first particular generative model.

In some of the various implementations, the method further includes: receiving an update to the cloud storage system that adds a third generative model to the cloud storage system; and fine-tuning the loss function to select, for a second given user query, a second particular generative model from the updated set of generative models that balances a cost of processing the second given user query and a quality of the second particular generative model.

In some of the various implementations, the second particular generative model is different from the first particular generative model.

In some implementations, a method implemented using processor(s) is provided and includes receiving a generative model request that is submitted by a submitting entity. The method further includes, in response to receiving the generative model request: identifying one or more custom selection features, that are customized by the submitting entity, to utilize for the generative model request; selecting, based on processing the generative model request and the identified one or more custom selection features, a particular generative model from a set of generative models; and causing, in response to selecting the particular generative model, the generative model request to be processed using the selected particular generative model. The one or more custom selection features are identified, for utilization for the generative model request, in response to the request being received from the submitting entity and in response to the one or more custom selection features being customized by the submitting entity.

These and other implementations disclosed herein can include one or more of the following features.

In some implementations, selecting the particular generative model from the set of generative models includes: processing the generative model request and the identified one or more custom selection features, using one or more routing models, to generate a model selection indication that indicates the particular generative model being selected; and selecting the particular generative model based on the model selection indication that indicates the particular generative model being selected. In some versions of those implementations, processing the generative model request and the identified one or more custom selection features, using the one or more routing models, to generate the model selection indication includes: processing the generative model request as input, using a first routing model (e.g., a first neural network model), from the one or more routing models, to generate a first model output indicating a set of selection scores each being for a respective generative model from the set of generative models; and processing the first model output and the identified one or more custom selection features, to generate the model selection indication that indicates the particular generative model being selected. In some of those versions, processing the first model output and the identified one or more custom selection features, to generate the model selection indication includes processing the first model output and the identified one or more custom selection features as input, using a second routing model (e.g., a second neural network model distinct from the first routing model), to generate a second model output reflecting the model selection indication that indicates the particular generative model being selected. In some additional or alternative versions of those implementations, identifying the one or more custom selection features includes identifying a second routing model based on the second routing model being fine-tuned based on the one or more custom selection features customized by the submitting entity—and processing the generative model request and the identified one or more custom selection features, using the one or more routing models, to generate the model selection indication includes: processing the generative model request as input, using a first routing model, from the one or more routing models, to generate a first model output indicating a set of selection scores each being for a respective generative model from the set of generative models; and processing the first model output, using the second routing model, to generate the model selection indication that indicates the particular generative model being selected. In some of those additional or alternative versions, the second routing model includes a base model, that is not fine-tuned based on the one or more custom selection features customized by the submitting entity, paired with a low-rank adaptation adapter that is fine-tuned based on the one or more custom selection features. In some of those additional or alternative versions, the second routing model is fine-tuned, based on the one or more custom selection features customized by the submitting entity, by being trained using positive and/or negative training instances that are specified by the submitting entity and that indirectly specify the one or more custom selection features. Optionally, the method can further include fine-tuning the second routing model based on the one or more custom selection features customized by the submitting entity.

In some implementations, the one or more custom selection features include a safety constraint. In some versions of those implementations, the safety constraint is determined prior to receiving the generative model request. In some of those versions, the safety constraint is determined based on user interaction with a graphical user interface (GUI) element, that is rendered via a display, to define the safety constraint from a plurality of predefined safety constraints, and the safety constraint is stored as being customized by the submitting entity in response to the user interaction being verified as being from the submitting entity (e.g., being submitted when logged-in to a verified account for the submitting entity).

In some implementations, the one or more custom selection features include a maximum cost limit for processing the generative model request.

In some implementations, the one or more custom selection features include a throughput requirement.

In some implementations, causing the generative model request to be processed using the selected particular generative model includes transmitting the generative model request to an API or other endpoint for the particular generative model. In some versions of those implementations, a generative model response is received from the endpoint responsive to the transmitting. In some of those versions, the method further includes causing the generative model response to be transmitted, to the submitting entity, responsive to the generative model request. For example, if the generative model request is received from a system of the submitting entity, the generative model response can be transmitted to the system of the submitting entity.

In some implementations, a method implemented using processor(s) is provided and includes receiving a generative model request and processing the generative model request as input using a first routing model, to generate a first routing model output indicating a set of selection scores, wherein each selection score, in the set of selection scores, corresponds to one of a set of generative models. The method further includes determining, based on the generative model request, an indication of a submitting entity that submitted the generative model request. The method further includes identifying, using the indication of the submitting entity, one or more custom selection features that are specific to the submitting entity. The method further includes selecting a particular generative model, from the set of generative models, wherein selecting the particular generative model is based on the one or more custom selection features and the set of selection scores. The one or more custom selection features are utilized in the selecting in response to the one or more custom selection features being specific to the submitting entity that submitted the generative model request. The method further includes, in response to selecting the particular generative model, causing the generative model request to be processed using the selected particular generative model.

These and other implementations disclosed herein can include one or more of the following features.

In some implementations, selecting the particular generative model includes: processing the one or more custom selection features and the set of selection scores as input, using a second routing model, to generate a model selection indication reflecting a selection of the particular generative model from the set of generative models; and selecting the particular generative model based on the model selection indication.

In some implementations, the set of generative models include a first generative model and a second generative model that is different from the first generative model, and wherein the set of selection scores include a first selection score determined for the first generative model and a second selection score determined for the second generative model.

In some implementations, the one or more custom selection features include a safety constraint. In some versions of those implementations, the safety constraint is determined prior to receiving the generative model request. In some of those versions, the safety constraint is determined based on user interaction with a graphical user interface (GUI) element, that is rendered via a display, to define the safety constraint from a plurality of predefined safety constraints, and the safety constraint is stored as being specific by the submitting entity in response to the user interaction being verified as being from the submitting entity.

In some implementations, the one or more custom selection features include a maximum cost for processing the user query.

In some implementations, the one or more custom selection features include a throughput requirement.

In some implementations, the first routing model is a neural network trained using a loss function that balances a cost of processing a corresponding query using a corresponding generative model and a quality of the corresponding generative model. In some of those implementations, the method further includes receiving an update that adds a further generative model to the set of generative models, and fine-tuning the first routing model using the loss function and using data that is specific to the added further generative model.

In some implementations, in response to selecting the particular generative model, the generative model request is caused to be processed using the selected particular generative model and is caused to be processed using the selected particular generative model and without any processing using any other of the generative models of the set.

In some implementations, identifying, using the indication of the submitting entity, the one or more custom selection features that are specific to the submitting entity, includes identifying a second routing model that is fine-tuned to the one or more custom selection features that are specific to the submitting entity. In some of those implementations, selecting the particular generative model, from the set of generative models and based on the one or more custom selection features and the set of selection scores, includes using the second routing model and the set of selection scores in selecting the particular generative model.

In some implementations, using the second routing model and the set of selection scores in selecting the particular generative model includes: processing the set of selection scores, using the second generative model, to generate a refined set of selection scores; and using the refined set of selection scores in selecting the particular generative model. In some versions of those implementations, the second routing model includes a base model, that is not fine-tuned based on the one or more custom selection features customized by the submitting entity, paired with a low-rank adaptation adapter that is fine-tuned based on the one or more custom selection features. In some of those or other versions, the second routing model is fine-tuned, based on the one or more custom selection features customized by the submitting entity, by being trained using positive and/or negative training instances that are specified by the submitting entity. In some of those or other versions, the method further includes fine-tuning the second routing model based on the one or more custom selection features customized by the submitting entity.

In some implementations, causing the generative model request to be processed using the selected particular generative model includes transmitting the generative model request to an API or other endpoint for the particular generative model. In some versions of those implementations, a generative model response is received from the endpoint responsive to the transmitting. In some of those versions, the method further includes causing the generative model response to be transmitted, to the submitting entity, responsive to the generative model request. For example, if the generative model request is received from a system of the submitting entity, the generative model response can be transmitted to the system of the submitting entity.

What is claimed is:

1. A method implemented using one or more processors, the method comprising:
receiving a generative model request, the generative model request being received from a submitting entity; and
in response to receiving the generative model request:
identifying one or more custom selection features, that are customized by the submitting entity, to utilize for the generative model request,
wherein the one or more custom selection features are identified, for utilization for the generative model request, in response to the request being received from the submitting entity and in response to the one or more custom selection features being customized by the submitting entity,
selecting, based on processing the generative model request and the identified one or more custom selection features, a particular generative model from a set of generative models, and
in response to selecting the particular generative model:
causing the generative model request to be processed using the selected particular generative model.

2. The method of claim 1, wherein selecting the particular generative model from the set of generative models comprises:
processing the generative model request and the identified one or more custom selection features, using one or more routing models, to generate a model selection indication that indicates the particular generative model being selected, and
selecting the particular generative model based on the model selection indication that indicates the particular generative model being selected.

3. The method of claim 2, wherein processing the generative model request and the identified one or more custom selection features, using the one or more routing models, to generate the model selection indication comprises:
processing the generative model request as input, using a first routing model, from the one or more routing models, to generate a first model output indicating a set of selection scores each being for a respective generative model from the set of generative models, and
processing the first model output and the identified one or more custom selection features, to generate the model selection indication that indicates the particular generative model being selected.

4. The method of claim 3, where processing the first model output and the identified one or more custom selection features, to generate the model selection indication comprises:
processing the first model output and the identified one or more custom selection features as input, using a second routing model, to generate a second model output reflecting the model selection indication that indicates the particular generative model being selected.

5. The method of claim 4, wherein the first routing model includes a first neural network, and the second routing model includes a second neural network different from the first neural network.

6. The method of claim 2, wherein identifying the one or more custom selection features comprises identifying a second routing model based on the second routing model being fine-tuned based on the one or more custom selection features customized by the submitting entity, and wherein processing the generative model request and the identified one or more custom selection features, using the one or more routing models, to generate the model selection indication comprises:
processing the generative model request as input, using a first routing model, from the one or more routing models, to generate a first model output indicating a set of selection scores each being for a respective generative model from the set of generative models, and
processing the first model output, using the second routing model, to generate the model selection indication that indicates the particular generative model being selected.

7. The method of claim 6, wherein the second routing model includes a base model, that is not fine-tuned based on the one or more custom selection features customized by the submitting entity, paired with a low-rank adaptation adapter that is fine-tuned based on the one or more custom selection features.

8. The method of claim 6, wherein the second routing model is fine-tuned, based on the one or more custom selection features customized by the submitting entity, by being trained using positive and/or negative training instances that are specified by the submitting entity and that indirectly specify the one or more custom selection features.

9. The method of claim 6, further comprising fine-tuning the second routing model based on the one or more custom selection features customized by the submitting entity.

10. The method of claim 1, wherein the one or more custom selection features include a safety constraint.

11. The method of claim 10,
wherein the safety constraint is determined prior to receiving the generative model request,
wherein the safety constraint is determined based on user interaction with a graphical user interface (GUI) element, that is rendered via a display, to define the safety constraint from a plurality of predefined safety constraints, and
wherein the safety constraint is stored as being customized by the submitting entity in response to the user interaction being verified as being from the submitting entity.

12. The method of claim 1, wherein the one or more custom selection features include a throughput requirement.

13. A method implemented using one or more processors, the method comprising:
receiving a generative model request;
in response to receiving the generative model request:,
processing the generative model request as input using a first routing model, to generate a first routing model output indicating a set of selection scores, wherein each selection score, in the set of selection scores, corresponds to one of a set of generative models, and
determining, based on the generative model request, an indication of a submitting entity that submitted the generative model request;
identifying, using the indication of the submitting entity, one or more custom selection features that are specific to the submitting entity;
selecting a particular generative model, from the set of generative models, wherein selecting the particular generative model is based on the one or more custom selection features and the set of selection scores,
wherein the one or more custom selection features are utilized in the selecting in response to the one or more custom selection features being specific to the submitting entity that submitted the generative model request; and
in response to selecting the particular generative model:
causing the generative model request to be processed using the selected particular generative model.

14. The method of claim 13, wherein selecting the particular generative model comprises:
processing the one or more custom selection features and the set of selection scores as input, using a second routing model, to generate a model selection indication reflecting a selection of the particular generative model from the set of generative models, and
selecting the particular generative model based on the model selection indication.

15. The method of claim 13, wherein the set of generative models include a first generative model and a second generative model that is different from the first generative model, and wherein the set of selection scores include a first selection score determined for the first generative model and a second selection score determined for the second generative model.

16. The method of claim 13, wherein the one or more custom selection features include a safety constraint.

17. The method of claim 16,
wherein the safety constraint is determined prior to receiving the generative model request,
wherein the safety constraint is determined based on user interaction with a graphical user interface (GUI) element, that is rendered via a display, to define the safety constraint from a plurality of predefined safety constraints, and
wherein the safety constraint is stored as being specific by the submitting entity in response to the user interaction being verified as being from the submitting entity.

18. The method of claim 13, wherein the first routing model is a neural network trained using a loss function that balances a cost of processing a corresponding query using a corresponding generative model and a quality of the corresponding generative model.

19. The method of claim 18, further comprising:
receiving an update that adds a further generative model to the set of generative models, and
fine-tuning the first routing model using the loss function and using data that is specific to the added further generative model.

20. The method of claim 13, wherein, in response to selecting the particular generative model:
the generative model request is caused to be processed using the selected particular generative model and is caused to be processed using the selected particular generative model and without any processing using any other of the generative models of the set.
